(19) United States
(12) Patent Application Publication
(10) Pub. No.: US 2005/0043002 A1
(43) Pub. Date: Feb. 24, 2005

(54) Method and apparatus for direct digital to rf conversion using pulse shaping

(76) Inventors: Cecile Vienney, Bordeaux (FR); Cedric De Coninck, Cestas-Gazinet (FR)

Correspondence Address: Lerner David Littenberg;Krumholz & Mentlik, 600 South Avenue West, Westfield, NJ, 07090, US

(21) Appl. No.: 10/489,633

(22) PCT Filed: Sep. 12, 2002
(86) PCT No.: PCT/CA02/01387

Related U.S. Application Data
(60) Provisional application No. 60/318,639, filed on Sep. 13, 2001.

(51) Int. Cl. H04B 1/26

(52) U.S. Cl. 455/323

(57) ABSTRACT

The invention described herein provides a method and apparatus that allows direct digital to IF/RF conversion using pulse-shaping. The method facilitates obtaining a flat or near flat output spectrum after digital to analog conversion with a minimal loss in signal energy. As opposed to pulse-shortening, where the DAC output pulse and consequently the energy per sample are reduced to a fraction a<1 of the maximum, the pulse-shaping does not shorten the DAC pulse. For each sample, pulse-shaping first stores the energy delivered by DAC and then releases the stored energy to the output during a short period of time aT. This way little signal energy is lost even for very small values of a. With pulse-shaping, the duration aT of the output pulse contributes to the spectral flatness in a way similar to that pulse-shortening, but has the additional benefit that the shape of the output pulse contributes significantly to a flat spectrum. Two embodiments of the pulse-shaping method are described in the context of two types of DAC that are used: one with current output and the other with voltage output. Then, two examples of pulse-shaping implementation are given for a single-ended current-output DAC and for a differential current-output DAC.

### FIELD OF THE INVENTION

The present invention relates to wireless data communications systems and is particularly concerned with direct digital to RF conversion.

### BACKGROUND OF THE INVENTION

With advances in digital technology and digital signal processing, more and more functionality is moved from analog circuits to digital circuits. This has many advantages including higher integration, steeper costs descend, accuracy, repeatability and reliability. Digital communications is one the fields that have both driven and tremendously benefited from this trend.

Many digital receivers today utilize IF (intermediate frequency) or RF (radio frequency) sampling to reduce the number of analog components to a minimum. With IF/RF sampling, the sample and hold (S/H) analog to digital converter (ADC) samples and quantize directly the IF/RF signal as opposed to base-band sampling where the signal is first down-converted to base-band (low frequencies), filtered and that sampled. IF/RF sampling provides better performance (precise filtering and quadrature demodulation) while reducing the number of analog components (local oscillator, mixer, amplifiers, filters). In order to increase the analog input signal frequency f without raising the clock frequency for the ADC f_{CLK}, IF/RF sampling utilizes sub-sampling. With sub-sampling, for an analog frequency band fₘᵢₙ<f<fₘₐₓ, f_{CLK} is chosen such that there exists an integer n that satisfies: n·f_{CLK}/2<fₘᵢₙ and fₘₐₓ<(n+1)·f_{CLK}/2. Sub-sampling implicitly down-converts the signal from f to f−rnd(n/2)·f_{CLK·}, where rnd( ) denotes rounding to the nearest integer. The integer rnd(n/2) is called sub-sampling factor and can be as large as tens or hundreds depending on the design.

Theoretically, sub-sampling can be also applied at the transmission since the digitized signal has a repetitive frequency spectrum with a period of f_{CLK}. The repetitions are usually called images and spectrum between 0 and f_{CLK}/2 is typically called main image. Sub-sampling could be used at transmission if the digital to analog converter (DAC) could output each sample as an infinitely short pulse of energy proportional with the sample value. This is not possible, because an infinitely short pulse with non-zero energy must have infinite amplitude. Therefore, typical DAC implementations output each sample as a pulse having the energy proportional with the sample value and the duration equal to the sample period T=1/f_{CLK}. Mathematically, this is equivalent to multiplying the digital signal spectrum by an attenuated sine function:
sinc(f)=sin(2π·f/f_{CLK})/(2π·f/f_{CLK}).

FIG. 1 shows the power spectral density (PSD) for a typical DAC, clocked at 100 MHz, with the main image being centered at 25 MHz and having approximately 24 MHz bandwidth. We note that images extend to and beyond 1000 MHz. However, we note that the signal level and implicitly the signal to noise ratio (SNR) decreases with frequency. For example, the image at 825 MHz is attenuated more that 30 dB and has less than 20 dB SNR, compared to the main image that has almost 50 dB SNR. We also note that all the images except the main one suffer significant linear distortions with differences in frequency response between fₘᵢₙ and fₘₐₓ as high as 7-8 dB.

To overcome the effects of the attenuated sine, some DAC manufactures have proposed shortening the DAC pulse to a fraction of the sample period T aT, a<1. With a shortened pulse, the attenuated sine function becomes:
sinc(a·f)=sin(2π·a·f/f_{CLK})/(2π·a·f/f_{CLK})
One can easily prove that the smaller the a, the flatter the spectrum. Unfortunately, decreasing a causes a proportional decrease in the energy per sample, the signal power and consequently the SNR.

FIG. 2 shows the power spectral density (PSD) for a pulse-shortening DAC with a=⅙ and clocked at 100 MHz. Again, the main image is centered at 25 MHz and has approximately 24 MHz bandwidth. We note that the signal level for the main image is reduced by almost 8 dB, compared to that of FIG. 1, but the response at the high frequencies is definitively improved. For example the image at 825 MHz is attenuated approximately 22 dB and has almost 30 dB SNR. We note also that linear distortions now affect only part of the images. For the image at 825 MHz there is practically no linear distortion.

One can infer that making a smaller would produce better and better results. Unfortunately, for small a values the improvement in the frequency response is offset by the reduction in the overall signal energy. FIG. 3 shows the power spectral density (PSD) for a pulse-shortening DAC with a=1/20 and clocked at 100 MHz. The main image is again centered at 25 MHz and has an approximately 24 MHz bandwidth. We note that, for the main image, the signal level is reduced by 13 dB and the SNR is approximately 38 dB. The frequency response is almost flat, with all images attenuated less then 5 dB in comparison with the main one. However, their performance cannot be better than the main image, which is already strongly attenuated. By taking all possible combinations one can easily show that the image at 825 MHz is always attenuated at least 15 dB and therefore, it cannot provide an SNR better than 36 dB.

### SUMMARY OF THE INVENTION

The invention described herein provides a method and apparatus that allows direct digital to IF/RF conversion using pulse-shaping. The method facilitates obtaining a flat or near flat output spectrum after digital to analog conversion with a minimal loss in signal energy. As opposed to pulse-shortening, where the DAC output pulse and consequently the energy per sample are reduced to a fraction a<1 of the maximum, the pulse-shaping does not shorten the DAC pulse. For each sample, pulse-shaping first stores the energy delivered by DAC and then releases the stored energy to the output during a short period of time aT. This way little signal energy is lost even for very small values of a. With pulse-shaping, the duration aT of the output pulse contributes to the spectral flatness in a way similar to that pulse-shortening, but has the additional benefit that the shape of the output pulse contributes significantly to a flat spectrum.

In the following sections, two embodiments of the pulse-shaping method are described in the context of two types of DAC that are used: one with current output and the other with voltage output. Then, two examples of pulse-shaping implementation are given for a single-ended current-output DAC and for a differential current-output DAC.

### BRIEF DESCRIPTION OF THE DRAWINGS

The present invention will be further understood from the following detailed description with reference to the drawings in which:

FIG. 1 graphically illustrates the power spectral density. (PSD) for a typical digital-to-analog converter (DAC);

FIG. 2 graphically illustrates the power spectral density (PSD) for a typical digital-to-analog converter (DAC) with pulse-shortening for a=⅙;

FIG. 3 graphically illustrates the power spectral density (PSD) for a typical digital-to-analog converter (DAC) with pulse-shortening for a=1/20;

FIG. 4 illustrates a typical current-output digital-to-analog converter (DAC);

FIG. 5 illustrates a digital-to-analog converter (DAC) with pulse-shaping in accordance with a first embodiment of the present invention;

FIG. 6 illustrates a typical voltage-output digital-to-analog converter (DAC);

FIG. 7 illustrates a digital-to-analog converter (DAC) with pulse-shaping in accordance with a second embodiment of the present invention;

FIG. 8 illustrates a first implementation of the embodiment of FIG. 5;

FIG. 9 illustrates a second implementation of the embodiment of FIG. 5;

FIG. 10 illustrates a pulse and clock generator for the implementations of FIGS. 8 and 9:

FIG. 11 graphically illustrates the signals for the pulse and clock generator of FIG. 10;

FIG. 12 graphically illustrates the power spectral density (PSD) for a pulse-shaping digital-to-analog converter (DAC) with a=⅙;

FIG. 13 graphically illustrates the power spectral density (PSD) for a pulse-shaping digital-to-analog converter (DAC) with a=1/20

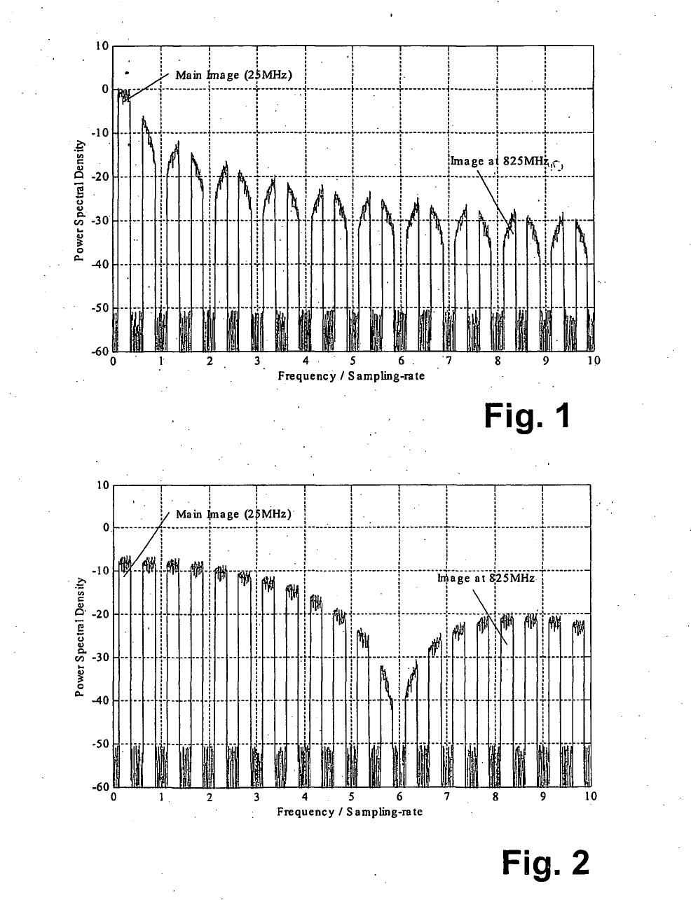

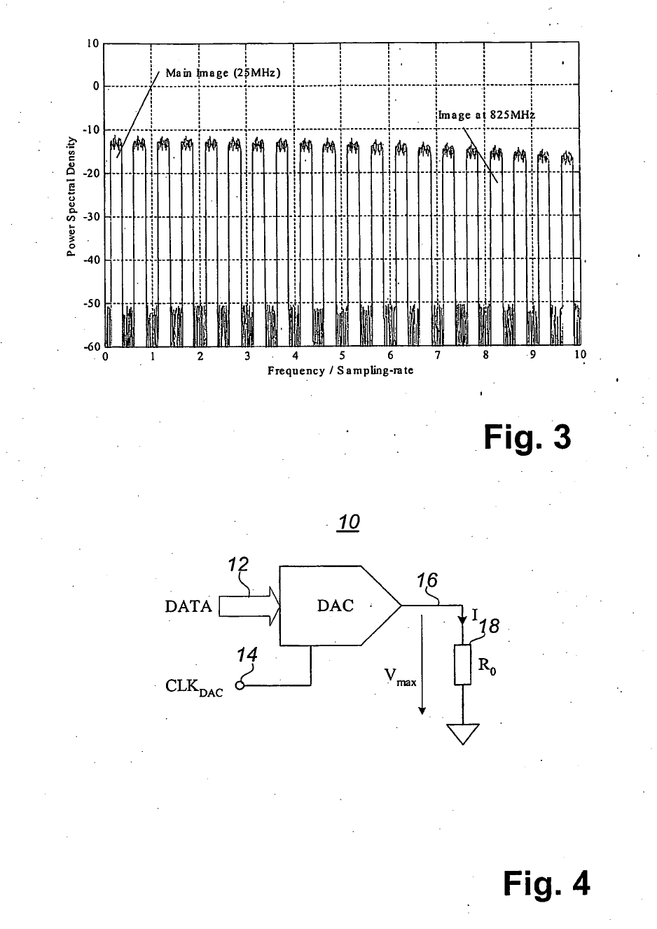

### DETAILED DESCRIPTION OF THE PREFERRED EMBODIMENT

Referring to FIG. 4 there is illustrated a typical current-output digital-to-analog converter (DAC). The DAC 10 has a data port 12 and a clock input 14 and an output 16 coupled it to ground through a load resistor (R) 18. With a current-output DAC as shown in FIG. 4, the output current I at a given moment is proportional to the last sample value written into the DAC 10, as long as the voltage at the DAC output 16 is smaller than a certain limit, Vₘₐₓ. The sample values are written into the DAC 10 through the DATA port 12 every rising (or every falling in certain implementations) edge of the CLK_{DAC}. The voltage limit V<Vₘₐₓ ensures the proper operation of the controlled current source at the DAC output 16. Knowing Vₘₐₓ and the full-scale current IFS one can calculate the maximum value for the load resistor as:
R₀=Vₘₐₓ/I_{FS}
Hence any resistor value larger than R₀ will prevent the DAC output from reaching the full-scale current due to voltage limitation. For each sample, the energy delivered by DAC to the load is:
E₀=R₀I²T
With a constant I, power delivered to the load is proportional with the load resistance and thus, using a load equal to R₀ maximizes the signal power at the output for the given DAC parameters Vₘₐₓ and I_{FS}.

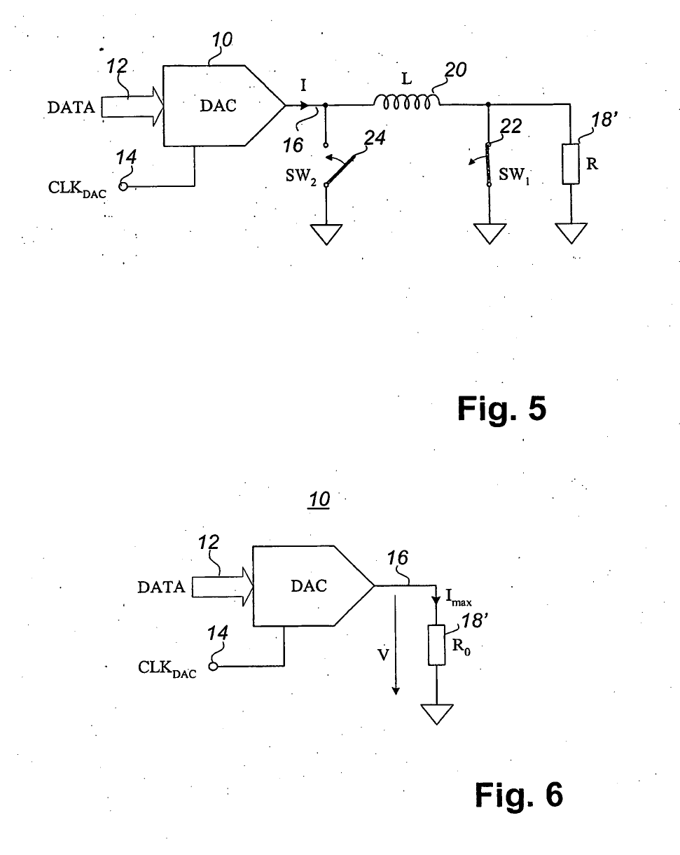

Referring to FIG. 5 there is illustrated a digital-to-analog converter (DAC) with pulse shaping in accordance with a first embodiment of the present invention. The DAC 10 has a data port 12 a clock input 14 and in the output 16. The output 16 is coupled to the load resistor 18′ through an inductor 20. A pair of switches 22 and 24 are operable to couple either side of the inductor 20 to ground.

In operation, with the pulse shaping method as described with regard to the first embodiment of the present invention, the energy produced by a current-output DAC 10 every sample is stored in the inductor 20 during a first stage and then released from the inductor 20 to the load 18′ during a second stage. The first stage lasts for a time (1−a)T while second stage lasts for a time aT. The principle of the method is shown in FIG. 5. The inductor 20, with value L, is used to store temporarily the energy. T is the load resistor 18′, a value of R. The first switch 22 (SW₁) stays closed in the first stage and opens in second stage. The second switch 24 (SW₂) is an optional switch that can be used to force the DAC output voltage to zero during the second stage. If used, SW₂ it is open in the first stage and closed in the second stage.

The value L of inductor 20 is chosen so that DAC output current can reach the full-scale value in less time than (1−a)T, hence L is given by:
L=Vₘₐₓ T(1−a)/I_{FS}=R₀ T(1−a)
The energy stored in inductor during the first stage is:
E_{L}=L I²/2=R₀ I² T(1−a)/2=E₀(1−a)/2
The current pulse through the load resistor has an exponential-decay shape:
i=I(1−exp(−t R/L))
where exp( ) denote the exponential function and t is the time elapsed from the moment SW1 opened and SW2 closed. When compared to the rectangular shape produced by pulse-shortening, the exponential shape smooths the zeros in the frequency response and therefore gives better performance at high frequencies. The steeper the exponential descend the flatter the output spectrum.
The energy transferred from L to the load R in the second stage is:
E_{R}=E_{L}(1−exp(−2 a T R/L))=E_{L}(1−exp(−2 a/(1−a)R/R₀))
E_{R} can be rewritten as:
E_{R}=E₀(1−a)/2(1−exp(−2 a/(1−a)R/R₀))
For any given a, one can always choose a load resistor R such that exp(−2 a/(1−a) R/R₀) is arbitrarily close to zero. Larger R values will give sharper exponential descend and better energy transfer from L to R. Also, for the purpose of the present embodiment of the invention, we expect a to be less than ½ (actually much less than). Thus, with a desired design, E_{R} will not be less than E₀/4. At the same time E_{R} is always less than E₀/2. Recall that E₀ is the energy delivered by DAC over one sample into an optimal load R₀ according to the known method. We see that, using the pulse shaping method disclosed herein, one can use arbitrarily short pulses (small a values) and maintain the output signal power within 3-6 dB of the power delivered by the known conversion method. Note also that energy efficiency limit (1−a)/2 increases while a decreases, which means that efficiency levels closer to 3 dB can be obtained for smaller a.

Referring to FIG. 6 there is illustrated a typical voltage-output digital-to-analog converter (DAC). With a voltage-output DAC as shown in FIG. 6, the output voltage V at a given moment is proportional with the last sample value written into the DAC as long as the current at the DAC output is less than a certain limit Iₘₐₓ. This current limitation ensures proper operation of the controlled voltage source at the DAC output. Knowing Iₘₐₓ and the full-scale voltage V_{FS} one can calculate the minimum value for the load resistor as:
R₀—V_{FS}/Iₘₐₓ
Any resistor value less than R₀ will prevent the DAC output from reaching the full-scale voltage due to current limitation. For each sample, the energy delivered by DAC to the load is:
E₀=V²/R₀T
With a constant V, power delivered to the load is inversely proportional to the load resistance and thus, using a load equal to R₀ maximizes the signal power at the output for the given DAC parameters V_{FS} and Iₘₐₓ.

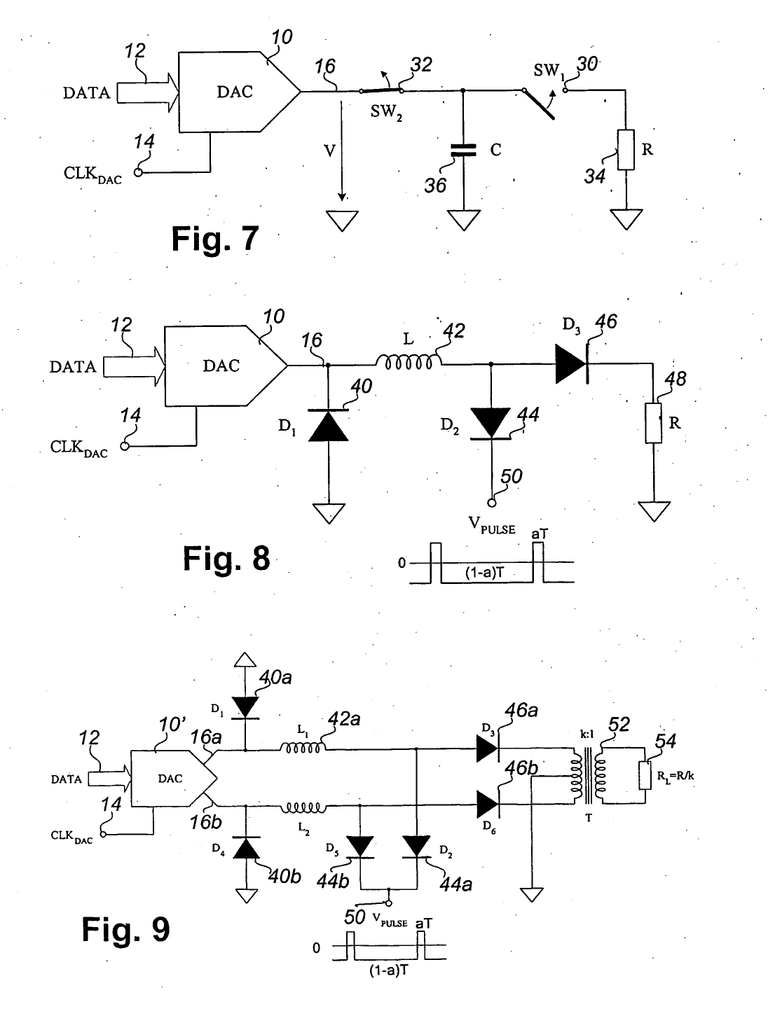

Referring to FIG. 7 there is illustrated a digital-to-analog converter (DAC) with pulse-shaping in accordance with a second embodiment of the present invention. The DAC 10 has a data port 12 a clock input 14 and in the output 16. The output 16 is coupled via first and second switches 30 and 32 to a load resistor 34. A capacitor 36 is coupled between the first and second switches 30 and 32 and ground.

In operation, with the pulse shaping method as described with regard to the second embodiment of the present invention, the energy produced by a voltage-output DAC every sample is stored in a capacitor during a first stage and then released from the capacitor to the load during a second stage. The first stage lasts a time (1−a)T while second stage lasts a time aT. The principle of the method is shown in FIG. 7. The capacitor 36 having a value C is used to temporarily store the energy output by the DAC 10. The load resistor 34 has a value R. The switch 30 (SW₁) stays open during the first stage and is closed for the second stage. The switch 32 (SW₂) is an optional switch that can be used to force the DAC output current to zero during the second stage. If used, SW₂ is closed during the first stage and open during the second stage. If SW₂ is not used, it is replaced by a short-circuit.

We choose the value C of the capacitor 36, such that DAC output voltage can reach the full-scale value in less than (1−a)T
C=Iₘₐₓ T(1−a)/V_{FS}=T(1−a)/R₀
The energy stored in capacitor during the first stage is:
E_{C}=C V²/2=V² T(1−a)/(2 R₀)=E₀(1−a)/2
The current pulse through the load resistor has an exponential-decay shape:
i=I(1−exp(−t/(R C))
where exp( ) denotes the exponential function and t is the time elapsed from the moment SW1 closed and SW2 opened. When compared to the rectangular shape produced by pulse-shortening, the exponential shape smoothens the zeros in the frequency response and therefore gives better performance at high frequencies. The steeper the exponential descend the flatter the output spectrum.
The energy transferred from the capacitor 36, whose value is C, to the load resistor 34 whose value is R during the second stage is:
E_{R}=E₀(1−exp(−2 a T/(R C)))=E_{C}(1−exp(−2 a/(1−a)R₀/R))
E_{R} can be rewritten as:
E_{R}=E₀(1−a)/2(1−exp(−2 a/(1−a)R⁰/R))
For any given a, one can always choose a load resistor value R such that exp(−2 a/(1−a) R₀/R) is arbitrarily close to zero. A smaller value of R will give sharper exponential descend and better energy transfer from the capacitor 36 to the resistor 34. Also, for the purpose of this embodiment of the present invention, we expect a to be less than ½ (actually much less than). Thus, with a desired design E_{R} should not be less than E₀/4. At the same time E_{R} is always less than E₀/2. Recall that E₀ is the energy delivered by DAC over one sample into an optimal load R₀ according to the standard method. We see that, using the pulse shaping method disclosed herein, one can use arbitrarily short pulses (small a values) and still maintain the output signal power within 3-6 dB of the power delivered by the known conversion method. Note also that energy efficiency limit (1−a)/2 increases while a decreases, which means that efficiency levels closer to 3 dB can be obtained for smaller a values.

Referring to FIG. 8 there is illustrated a first implementation of the embodiment of FIG. 5. The DAC 10 has a data port 12, a clock input 14 and in the output 16. The output 16 is coupled to the load resistor 48 through an inductor 42. A first diode couples ground the output 16 to ground in the forward biased direction. Second and third diodes 44 and 46, in forward biased direct couple the inductor 42 to a Vₚᵤₗₛₑ input 50 and the load resistor 48, respectively.

Most of the high-speed DAC available on market today have a current output.

FIG. 8 shows a possible implementation of the pulse-shaping for a current-output DAC. When compared to FIG. 5, we see that SW₁ is implemented using the high-speed diodes 44 and 46 (D₂ and D₃) and that SW₂ is implemented with the high-speed diode 40 (D₁). The control of the two switches implemented with diodes is performed via the periodic voltage V_{PULSE} input at 50. V_{PULSE} is negative for a time (1−a)T and positive for a time aT.

When V_{PULSE} is negative, the second diode 44 (D₂) is forward biased, thus acts like a closed switch. At the same time the first and second diodes 40 and 46 (D₁ and D₃) are reversed biased and therefore they act like open switches. Then, the output current of the DAC flows to ground via the inductor 42 and the second diode 44. The voltage on the load resistor 48 is zero.

When V_{PULSE} is positive, the second diode 44 is reversed biased and thus acts like an open switch. The energy stored in the inductor 42 forward biases the third diode 46, i.e. makes it act like a closed switch, and discharges the inductor through the third diode 46 into the load resistor 48. The first diode 40 can be forward biased if the current in the inductor 42 exceeds the DAC output-current, in which case the first diode 40 acts like a closed switch, and hence protects the DAC output against negative voltages.

Referring to FIG. 9 there is illustrated a second implementation of the embodiment of FIG. 5. Many high-speed DACs produced today have differential current output. With such a DAC, there are two current outputs, one sourcing the current I proportional with the last sample value written into DAC and the other one sourcing I_{FS}-I. FIG. 9 shows a possible implementation of the pulse-shaping for a differential current-output DAC. The pulse-shaping differential output DAC 10′ includes an upper branch coupled to an output 16a and having a first diode 40a coupled to ground, a first inductor 42a, a second diode 44a coupled to a V_{PULSE} input 50 and a third diode 46a coupled to one end of a primary of a k:1 transformer 52 whose center is grounded. DAC 10′ similarly includes a lower branch coupled to an output 16b and having a fourth diode 40b coupled to ground, a second inductor 42b, a fifth diode 44b coupled to the V_{PULSE} input 50 and a sixth diode 46b coupled to the other end of primary of a k:1 transformer 50. The load resistor 52 is coupled across the secondary of the transformer 50 and has a value R_{L}=R/k.

When compared to FIG. 5, we see that SW₁ is implemented on each branch using two high-speed diodes 44a, 46a (D₂, D₃) for upper branch and 44b, 46b (D₅, D₆) for the lower branch. We see also that SW₂ is implemented with one high-speed diode per branch 40a (D₁) on upper and 40b (D₄) on lower. Hence, the implementation is similar to that of FIG. 8.

In operation, the control of the two switches on each branch is performed by the periodic voltage V_{PULSE} applied at the input 50. V_{PULSE} is negative for a time (1−a)T and positive for aT. An addition beyond the previous implementation example (FIG. 8), is the transformer 52 used to convert the differential signal to a single ended one. The transformer 52 may have a k:1 impedance ratio that can be used to reduce the effective value of the load resistor by k times, i.e. R_{L}=R/k. This allows us to choose a large R. Recall that a larger R results in better energy transfer from inductors to load and also improves the flatness of the spectrum.

When V_{PULSE} is negative, diodes 44a and 44b (D₂ and Ds) are forward biased and thus they act like closed switches. At the same time all the other diodes are reversed biased and therefore they act like open switches. Then, the output currents of the DAC flows to ground via the first inductor 42a. (L₁) and the second diode 44a (D₄) for the upper branch and the second inductor 42b (L₂) and the fifth diode 44b (D₅) for the lower. The voltage on the load resistor R is zero.

When V_{PULSE} is positive, diodes 44a and 44b (D₂ and D₅) are reversed biased and thus they act like an open switches. The energy stored in inductors 42a and 42b (L₁ and L₂) causes diodes 46a and 46b (D₃ and D₆) to become forward biased, i.e. these diodes act like closed switches, and the inductors 42a and 42b discharge through the primary windings of transformer 50 and coupled into the load resistor 52 via the secondary windings. If the current in inductors exceeds the DAC output-current, diodes 40a and 40b become forward biased, so that they act like closed switches and hence they protect the DAC outputs against negative voltages.

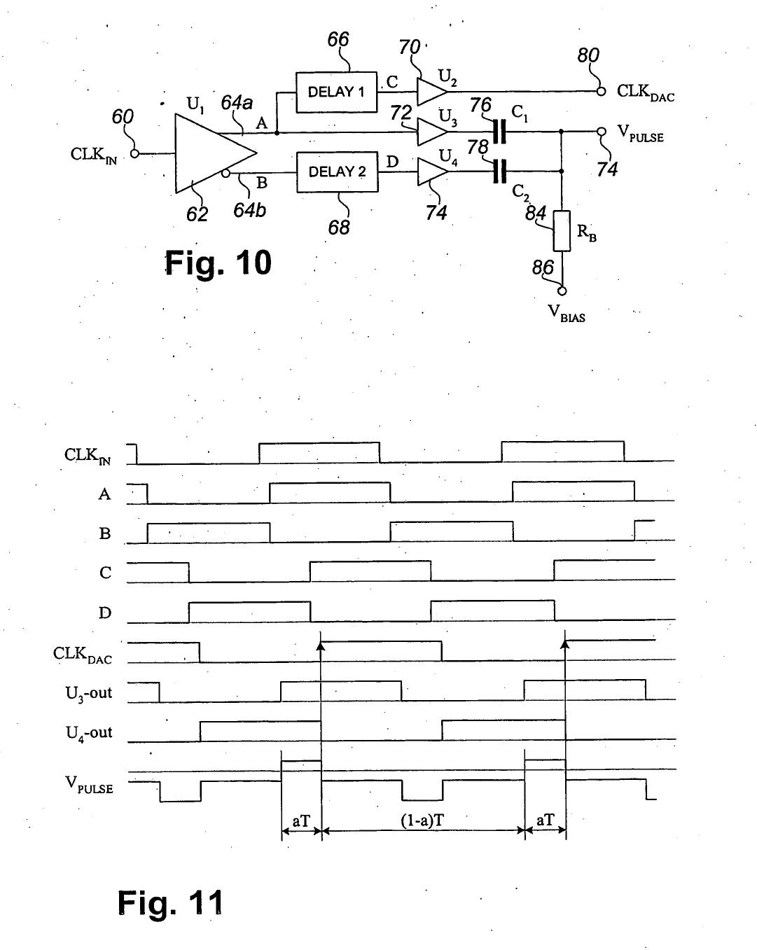

Referring to FIG. 10 there is illustrated a pulse and clock generator for the implementations of FIGS. 8 and 9. Both circuits in FIGS. 8 and 9 require a generator that will produce periodic pulses that have width aT and period T. FIG. 10 shows a simple solution to obtain these pulses from a clock signal of frequency 1/T. The pulse and clock generator includes a clock input 60 coupled to a buffer 62 (U₁) with non-inverted (A) and inverted (B) outputs 64a and 64b, respectively, a first delay 66 coupled to the non-inverting output 64a and a second delay 68 coupled to the inverting output 64b. Optionally three non-inverting buffers 70, 72, and 74 (U₂, U₃ and U₄) may be applied to the out of first delay 66, the non-inverting output 64a and second delay 68, respectively. The output of buffer 70 is applied as output to a DAC clock output 80. The output of buffer 72 is capacitively coupled via a capacitor 76 to Vₚᵤₗₛₑ output 82. The output of buffer 74 is also capacitively coupled via a capacitor 78 to Vₚᵤₗₛₑ output 82. A V_{bias} input 86 is coupled via a bias resistor 84 to a Vₚᵤₗₛₑ output 82.

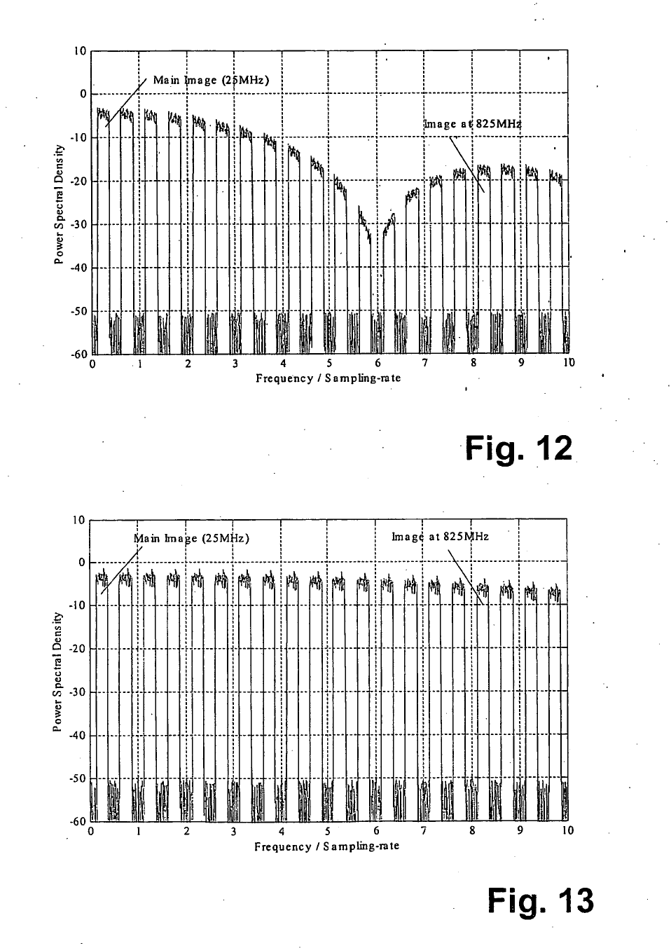

In operation, the non-inverted output (A) 64a from buffer 62 (U₁) is delayed through the first delay 66 and buffer 70 (U₂) to produce the clock for DAC (CLK_{DAC}) at the output 80. A delayed version of the output of the inverting output 64b (B) is added to (A) using U₃, U₄ and C₁, C₂ to produce V_{PULSE} at output 82. The resistor 84 (R_{B})) ensures a negative bias for V_{PULSE}. The operation of the pulse and clock generator is detailed in FIG. 11. The width of the pulse aT is controlled by the second delay 68. The first delay 66 is used to ensure proper alignment of CLK_{DAC} with V_{PULSE}. Note also that the circuit produces both positive and negative pulses with width aT, but only the positive ones are used (negative pulses have no effect).

Referring to FIG. 12 there is graphically illustrated the power spectral density (PSD) for a pulse-shaping digital-to-analog converter (DAC) with a=⅙. FIG. 12 shows the power spectral density (PSD) for a pulse-shaping DAC with a=⅙ and clocked at 100 MHz. The main image is centered at 25 MHz and has approximately 24 MHz bandwidth. Note that the signal level for the main image is reduced by only 4-5 dB compared to an 8 dB reduction obtained with a pulse-shortening DAC. The response at the higher frequencies is also better than with pulse shortening. For example, the image at 825 MHz is attenuated only 18 dB rather than 22 dB and has almost 34 dB SNR. Also note that the zero at 600 MHz (6 times the clock frequency) is smoother then with pulse-shortening. This is a result of the exponential-decay shape used with pulse-shaping. For the image at 825 MHz there is practically no linear distortion.

Referring to FIG. 13 there is graphically illustrated the power spectral density (PSD) for a pulse-shaping digital-to-analog converter (DAC) with a=1/20 FIG. 13 shows the power spectral density (PSD) for a pulse-shaping DAC with a=1/20 and clocked at 100 MHz. The main image is again centered at 25 MHz and has approximately 24 MHz bandwidth. Note that, for the main image, the signal level is reduced by only 4 dB as opposed to 13 dB obtained with pulse-shortening. Consequently, the SNR is almost 48 dB instead of 38 dB. The benefit of pulse-shaping becomes obvious at higher frequencies which are attenuated less than 4 dB compared to the main image. For example, the image at 825 MHz is attenuated only 7 dB and therefore exhibits almost 45 dB SNR as opposed to 36 dB obtained with the pulse-shortening DAC. As a further advantage, still better performance can be obtained if a is further reduced.

1. A method of direct digital to radio frequency conversion comprising the steps of:
sampling a digital signal;
storing energy for the sample; and
releasing the stored energy in a predetermined period, less then the period of the digital signal to produce an output pulse.

2. A method as claimed in claim 1 wherein the step of storing includes capacitively storing an output voltage sample.

3. A method as claimed in claim 2 wherein the step of capacitively storing an output voltage sample includes applying an output voltage across a capacitor for a first predetermined period.

4. A method as claimed in claim 3 wherein the step of releasing includes the step of discharging the capacitor for a second predetermined period.

5. A method as claimed in claim 4 when the second predetermined period is aT where T is the period of the digital signal and a is between zero and one.

6. A method as claimed in claim 1 by inductively storing an output current sample.

7. A method as claimed in claim 6 wherein inductively storing includes applying an output current to an inductor for a first predetermined period.

8. A method as claimed in claim 7 where the step of releasing the stored energy includes the step of connecting the inductor to a load for a second predetermined period.

9. A method as claimed in claim 8 when the second predetermined period is aT where T is the period of the digital signal and a is between zero and one.

10. Apparatus for direct digital to radio frequency conversion comprising:
means for sampling a digital signal;
means for storing energy for the sample; and
means for releasing the stored energy for a predetermined period, less then the period of the digital signal to produce an output pulse.

11. Apparatus as claimed in claim 10 wherein the means of storing comprises means for capacitively storing an output voltage sample.

12. Apparatus as claimed in claim 11 wherein the means for storing includes means for applying an output voltage across a capacitor for a first predetermined period.

13. Apparatus as claimed in claim 12 wherein the step of releasing includes the step of discharging the capacitor for a second predetermined period.

14. Apparatus as claimed in claim 13 when the second predetermined period is aT where T is the period of the digital signal and a is between zero and one.

15. Apparatus as claimed in claim 10 wherein the means for storing includes means for inductively storing an output current sample.

16. Apparatus as claimed in claim 15 including means for applying an output current to an inductor for a first predetermined period.

17. Apparatus as claimed in claim 16 including means for connecting the inductor to a load during a second predetermined period.

18. Apparatus as claimed in claim 17 when the second predetermined period is aT where T is the period of the digital signal and a is between zero and one.
